(19) United States
(12) Patent Application Publication
(10) Pub. No.: US 2003/0043473 A1
(43) Pub. Date: Mar. 6, 2003

(54) Liquid immersion type microscope objective lens

(75) Inventor: Yoko Okuyama, Fukaya-shi (JP)

Correspondence Address: MILES & STOCKBRIDGE PC, 1751 PINNACLE DRIVE, SUITE 500, MCLEAN, VA, 22102-3833, US

(73) Assignee: Nikon Corporation

(21) Appl. No.: 10/179,854

(22) Filed: Jun. 26, 2002

(30) Foreign Application Priority Data
Jun. 29, 2001 (JP) 2001-197620

(51) Int. Cl. G02B 21/02

(52) U.S. Cl. 359/659; 359/656

(57) ABSTRACT

A liquid immersion type microscope objective lens comprises a first lens group G1 having a positive refracting power, a second lens group G2 having a positive refracting power, a third lens group G3 having a negative refracting power, a fourth lens group G4, and a fifth lens group G5, in order from an object side. The first lens group G1 has a cemented lens which comprises a plano-convex lens with the plane surface facing the object side and a meniscus lens with the concave surface facing the object side cemented together, and a positive meniscus lens with the concave surface facing the object side. The second lens group G2 has a plurality of cemented surfaces having a negative refracting power. The third lens group G3 has a cemented lens which comprises a negative lens, a positive lens, and a negative lens cemented together. The fourth lens group G4 has a cemented meniscus lens which comprises a positive lens and a negative lens with the concave surface having a large curvature facing an image side, cemented together. The fifth lens group G5 has a cemented meniscus lens comprising a negative lens with the concave surface having a large curvature facing the object side and a positive lens cemented together. The fourth lens group G4 and fifth lens group G5 are arranged to be integrally movable along the optical axis in order to correct the aberration fluctuations.

This application claims the benefit of Japanese Patent application No. 2001-197620 which is hereby incorporated by reference.

### BACKGROUND OF THE INVENTION

1. Field of the Invention

The present invention relates to an objective lens of a liquid immersion type microscope, and particularly, to an objective lens suitable for a liquid immersion type microscope which conducts observation in a state that an optical path between the objective lens and an object to be observed is filled with liquid such as water or oil.

2. Related Background Art

In general, in order to enhance the resolving power in a microscopic observation, it is suffice if the numerical aperture of the objective lens is increased. Then, in order to increase the numerical aperture of the objective lens, it is suffice, as well known, if a gap between a specimen to be observed (an object to be observed) and the objective lens is filled with a liquid. As such a liquid (immersion liquid), oil (having the refractive index of about 1.52 with respect to the d line), glycerin (having the refractive index of about 1.47 with respect to the d line), or water (having the refractive index of about 1.33 with respect to the d line) may be employed.

Particularly, when water is used as the immersion liquid, since there is a difference in the refractive index between a cover glass (having the refractive index of 1.52 or around with respect to the d line) and the water, aberrations may fluctuate due to an error in thickness of the cover glass, i.e., due to a change of the thickness of the cover glass. As described above, a change of the thickness of a plane parallel plate such as the cover glass which is inserted between the object to be observed and the objective lens causes deterioration of the imaging performance of the objective lens. The tendency of thus deteriorating the imaging performance is more conspicuous when the numerical aperture of the objective lens is larger.

Accordingly, an objective lens of a water immersion type microscope is required to be a so-called an objective lens with a correction ring which is provided with a correction lens for correcting aberration fluctuations. As objective lenses with a correction ring of this type, liquid immersion type microscope objective lenses which are disclosed, for example, in Japanese Patent Application Laid-Open No. 8-292374, and No. 10-333044 are generally known.

The liquid immersion type microscope objective lens of a prior art which is disclosed in Japanese Patent Application Laid-Open No. 10-333044 mentioned above is an objective lens with a correction ring having the magnification of 40 and the numerical aperture of 1.15. However, in this disclosed liquid immersion type microscope objective lens of the prior art, the Petzval's sum is not so small that there arises a problem that the flatness of an image plane is not sufficiently corrected.

Recently, in the field of the biological studies and researches, there are widely used fluorescent microscopes which irradiate a specimen with short-wave rays such as ultraviolet rays as excitation rays to observe the fluorescence emitted from the specimen. Fluorescent optical materials usable for a microscope objective lens for fluorescence observation have various limitations. For instance, out of glass materials (optical glasses) having the Abbe number of not less than 30, a glass material having the Abbe number of not more than 49 and the refractive index of not less than 1.7 with respect to the d line (λ=587.56 nm) can not be used as the fluorescent glass material. Even outside this range, the glass materials usable for fluorescence observation are limited. In the conventional liquid immersion type microscope objective lens disclosed in Japanese Patent Application Laid-Open No. 8-292374 described above, no fluorescent glass material is used so that there is a problem that the objective lens can not fully display its performance as a microscope objective lens for fluorescence observation.

### SUMMARY OF THE INVENTION

The present invention has been contrived taking the above circumstances into consideration, and has its object to provide a liquid immersion type microscope objective lens of an apochromat level, which has, even when using a fluorescent glass material, the magnification of about 40 and the numerical aperture (NA) of about 1.2, with excellent flatness of the image surface, and can correct fluctuations of the aberrations caused by changes of the thickness of the cover glass, or the like.

In order to solve the above problems, according to the present invention, there is provided a liquid immersion type microscope objective lens comprising a first lens group G1 having a positive refracting power, a second lens group G2 having a positive refracting power, a third lens group G3 having a negative refracting power, a fourth lens group G4, and a fifth lens group G5, in the named order from an object side, characterized in that:

said first lens group G1 has a cemented lens which comprises a plano-convex lens with the plane surface facing the object side and a meniscus lens with the concave surface facing the object side cemented together, and a positive meniscus lens with the concave surface facing the object side, in the order from the object side;

said second lens group G2 has a plurality of cemented surfaces having a negative refracting power;

said third lens group G3 has a cemented lens which comprises a negative lens, a positive lens, and a negative lens cemented together, in the order from the object side;

said fourth lens group G4 has a cemented meniscus lens which comprises a positive lens and a negative lens with the concave surface having a large curvature facing an image side, cemented together in the order from the object side;

said fifth lens group G5 has a cemented meniscus lens which comprises a negative lens with the concave surface having a large curvature facing the object side and a positive lens cemented together in the order from the object side; and

said fourth lens group G4 and said fifth lens group G5 are arranged to be integrally movable along the optical axis in order to correct the aberration fluctuations.

According to a preferred embodiment of the present invention, the following condition is satisfied:

0.4<f/f1<0.6,

where the focal length of said objective lens is f, and the focal length of said first lens group G1 is f1.

According to a preferred embodiment of the present invention, in said second lens group G2, when the Abbe numbers of the positive lens and the negative lens for forming each of the cemented surfaces having the negative refracting power are ν21 and ν22, respectively, the following condition is satisfied on at least one of the cemented surfaces having the negative refracting power:

49<ν21−ν22.

Further, according to a preferred embodiment of the present invention, the following condition is satisfied:

(n1−n2)/|R|<0.01,

where, in the third lens group G3 the refractive-index of the negative lens on the object side with respect to the d line is n1, the refractive index of the central positive lens with respect to the d line is n2, and the radius of curvature of the cemented surface formed by the negative lens on the object side and the central positive lens is R.

### BRIEF DESCRIPTION OF THE DRAWINGS

FIG. 1 is a view for schematically showing the configuration of a liquid immersion type microscope objective lens according to a first embodiment of the present invention;

FIG. 2 is a view of aberrations in a state that the thickness of a cover glass (t=0.11) in the first embodiment is smaller than the standard thickness;

FIG. 3 is a view of aberrations in a state that the thickness of the cover glass in the first embodiment is equal to the standard thickness (t=0.17);

FIG. 4 is a view of aberrations in a state that the thickness of the cover glass (t=0.18) in the first embodiment is larger than the standard thickness;

FIG. 5 is a view for schematically showing the configuration of a liquid immersion type microscope objective lens according to a second embodiment of the present invention;

FIG. 6 is a view of aberrations in a state that the thickness of a cover glass (t=0.11) in the second embodiment is smaller than the standard thickness;

FIG. 7 is a view of aberrations in a state that the thickness of the cover glass in the second embodiment is equal to the standard thickness (t=0.17);

FIG. 8 is a view of aberrations in a state that the thickness of the cover glass (t=0.18) in the second embodiment is larger than the standard thickness; and

FIG. 9 is a view for showing the configuration of an imaging lens in each of the embodiments.

### DETAILED DESCRIPTION OF THE PREFERRED EMBODIMENTS

In a liquid immersion type microscope objective lens of the present invention, it is possible to decrease a Petzval' sum by making a front lens (the lens disposed closest to an object to be observed) of a first lens group G1 as a cemented lens and the curvature of a cemented surface thereof, and consequently it is possible to decrease the curvature of field thereof. Also, by suppressing a spherical aberration from being generated while suppressing the divergence of light rays by the function of a positive meniscus lens which is arranged immediately behind the front lens (on the image side), the light rays are guided toward a second lens group G2.

Note that, according to the present invention, a spherical aberration or a chromatic aberration is corrected by a plurality of cemented surfaces disposed in the second lens group G2 and having the negative refracting power. Also, it is possible to correct secondary dispersion of a longitudinal chromatic aberration by using an anomalous dispersion glass in a lens for forming the cemented surfaces. Further, a triplet cemented lens which comprises a negative lens, a positive lens and a negative lens cemented together is disposed in a third lens group G3, so as to make a spherical aberration and a coma aberration in a good balance.

A chromatic aberration of magnification, a coma aberration, and a curvature of field are corrected by forming a lens group of a Gaussian type with a fourth lens group G4 and a fifth lens group G5. Further, aberration fluctuations which may be caused by a change in the thickness of a cover glass are corrected upon movement of the correction lens groups (G4 and G5) of the Gaussian type formed by the fourth lens group G4 and the fifth lens group G5 in the direction of the optical axis.

In the following, the structure of the present invention will be fully described with reference to the respective conditions. According to the present invention, it is desirable to satisfy the following condition (1):

0.4<f/f1<0.6 (1),

where f is the focal length of an objective lens, and f1 is the focal length of the first lens group G1.

The condition (1) represents a condition for effectively performing correction of a spherical aberration, and the like, in the second lens group G2, and defines the power (refracting power) of the first lens group G1. Below the lower limit of the condition (1), the power of the first lens group G1 becomes too small so that the height of incidence of the light rays onto the second lens group G2 becomes high, which unfavorably weakens the effect of correction of the spherical aberration, and the like, in the second lens group G2.

On the other hand, above the upper limit of the condition (1), the power of the first lens group G1 becomes too strong to increase the Petzval's sum, so that the flatness of an image is unfavorably deteriorated. Besides, amounts of the generation of the spherical aberration as well as the longitudinal chromatic aberration becomes large, so that these aberrations can not be corrected satisfactorily unfavorably. Beyond the limits of the condition (1), amounts of the generation of the spherical aberration and the chromatic aberration caused by a change of the thickness of the cover glass become large, so that these aberrations can not be sufficiently corrected by the movement of the correction lens groups (the fourth lens group G4 and the fifth lens group G5) unfavorably.

Also, according to the present invention, it is preferable that at least one out of the plurality of cemented surfaces having the negative refracting power in the second lens group G2 should satisfy the following condition (2):

49<ν21 −ν22 (2),

where ν21 and ν22 are the Abbe numbers of the positive lens and the negative lens for forming each of the cemented surfaces having the negative refracting power in the second lens group G2.

The condition (2) represents a condition for effectively correcting the chromatic aberration, and defines an appropriate range for a difference between the Abbe number of the positive lens and that of the negative lens for forming the cemented surface having the negative refracting power in the second lens group G2 As described above, the fluorescent glass materials are limited, so that it is required to correct the chromatic aberration with efficiency in the second lens group G2 in which a land light passes in a higher part thereof. Beyond the limits of the condition (2), the chromatic aberration can not be corrected sufficiently, so as to render an unfavorable result.

Also, according to the present invention, it is preferable to satisfy the following condition (3):

(n1−n2)/|R|<0.01 (3),

where n1 is the refractive index of the negative lens on the object side in the third lens group G3 with respect to the d line, n2 is the refractive index of the central positive lens in the third lens group G3 with respect to the d line, and R is the radius of curvature of the cemented surface (that is, the cemented surface on the object side) formed by the negative lens on the object side and the central positive lens.

By satisfying the condition (3), it is possible to satisfactorily correct a coma aberration in a range having a large angle of view. Beyond the limits of the condition (3), the refracting power of the cemented surface on the object side becomes too strong so that it becomes difficult to correct the coma aberration and the spherical aberration in the range having a large angle of view in a good balance unfavorably.

Also, according to the present invention, it is preferable to satisfy the following condition (4):

|f4/f5|<0.1 (4),

where f4 is the focal length of the fourth lens group G4, and f5 is the focal length of the fifth lens group G5.

By satisfying the condition (4), it is possible to satisfactorily correct the coma aberration. In general, out of the objective lenses having the same numerical aperture, an objective lens having a lower magnification has a larger numerical aperture on the image plane side. In an objective lens having the magnification of 40 and the numerical aperture of 1. 2, light rays normally pass in a comparatively higher part in the fifth lens group G5 which is disposed closest to the image. As a result, beyond the limits of the condition (4), the focal length f5 of the fifth lens group G5 becomes small (the power becomes large) to deflect the light rays too strong, so that it becomes difficult to correct the coma aberration unfavorably.

Also, according to the present invention, it is preferable to satisfy the following condition (5):

13<ν51−ν52 (5),

where ν51 is the Abbe number of the negative lens in the fifth lens group G5, and ν52 is the Abbe number of the positive lens in the fifth lens group G5.

The condition (5) is a condition for suppressing a chromatic aberration which is generated by a movement of a correction lens group. Beyond the limits of the condition (5), the chromatic aberration which is caused by the movement of the correction lens group (correction ring) becomes large, so that an unfavorable result that an excellent imaging performance can not be obtained is brought about.

[Embodiments]

Embodiments of the present invention will be described with reference to the attached drawings.

In each of the embodiments, a liquid immersion type microscope objective lens of the present invention is composed of a first lens group G1 having a positive refracting power, a second lens group G2 having a positive refracting power, a third lens group G3 having a negative refracting power, a fourth lens group G4, and a fifth lens group G5, in that order from an object side. The microscope objective lens in each embodiment is of a water immersion type using water as an immersion liquid. The fourth lens group G4 and the fifth lens group G5 are arranged to be integrally movable along the optical axis for correcting aberration fluctuations which may be caused by a change of the thickness of a cover glass, etc., as correction lens groups (correction rings).

In each of the embodiments, the microscope objective lens is designed in an infinity. As a result, an imaging lens (a second objective lens) is disposed on an image side of the microscope objective lens to have a predetermined air gap therebetween, so as to constitute a finite optical system by combining the microscope objective lens and the imaging lens with each other. Note that aberration views shown in each of the embodiments show aberrations when an air gap along the optical axis between the microscope objective lens and the imaging lens is 148 mm. However, the present inventors have been found and confirmed that even when the air gap along the optical axis is changed to some extent, there arises little fluctuation of aberrations.

Also, in each of the embodiments, the standard thickness of the cover glass is t=0.17 mm, the refractive index of the cover glass with respect to the d line is nd=1.52216, and the Abbe number of the cover glass with respect to the d line is νd=58.80. Also, the refractive index of the immersion liquid with respect to the d line is nd=1.33306 and the Abbe number of the immersion liquid with respect to the d line is νd=53.98. Further, all of the lenses for constituting the objective lens are formed of fluorescent glass materials.

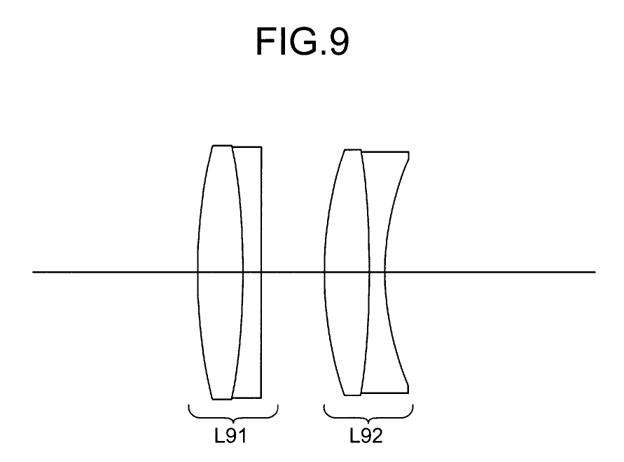

FIG. 9 is a view for showing the configuration of an imaging lens in each of the embodiments. As shown in FIG. 9, the imaging lens in each of the embodiments is composed of a cemented lens L91 consisting of a biconvex lens and a biconcave lens cemented together, and a cemented lens L92 consisting of a biconvex lens and a biconcave lens cemented together, in the order from the object side. Values for the specifications of the imaging lens in each of the embodiments are listed in the following Table (1). In Table (1), a surface number denotes the order of each lens surface from the object side, r denotes the radius of curvature (mm) of each lens surface, d denotes a gap (mm) between lens surfaces, nd denotes a refractive index of each lens surface with respect to the d line (Q=587.6 nm), and νd denotes an Abbe number of each lens surface with respect to the d line, respectively.

TABLE 1

| Surface number | r | d | nd | ν d | |
|---|---|---|---|---|---|
| 1 | 75.045 | 5.1 | 1.6228 | 57.0 | (L91) |
| 2 | −75.045 | 2.0 | 1.7495 | 35.2 | |
| 3 | 1600.580 | 7.5 | | | |
| 4 | 50.256 | 5.1 | 1.6676 | 42.0 | (L92) |
| 5 | −84.541 | 1.8 | 1.6127 | 44.4 | |
| 6 | 36.911 | | | | |

[First Embodiment]

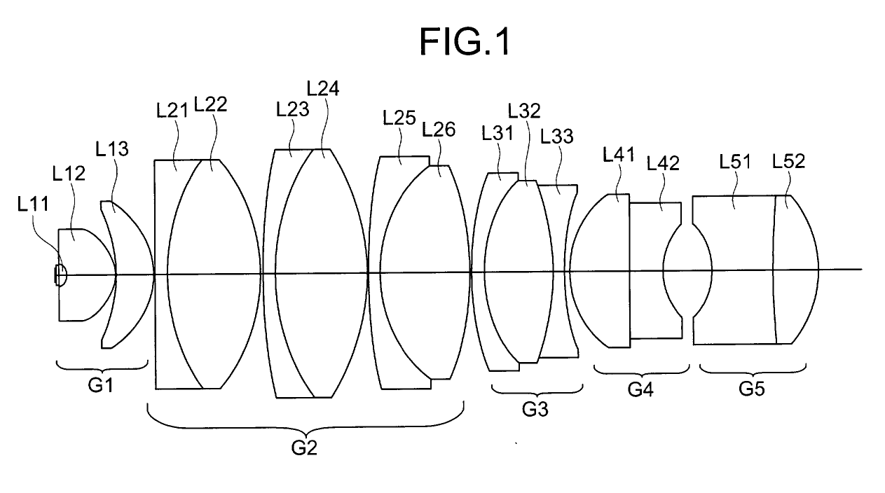

FIG. 1 is a view for schematically showing the configuration of a liquid immersion type microscope objective lens according to the first embodiment of the present invention. In the microscope objective lens shown in FIG. 1, a first lens group G1 is composed of a cemented lens consisting of a plano-convex lens L11 with the plane surface facing the object side and a negative meniscus lens L12 with the concave surface facing the object side cemented together, and a positive meniscus lens L13 with the concave surface facing the object side, in the order from the object side.

A second lens group G2 is composed of a cemented lens consisting of a negative meniscus lens L21 with the convex surface facing the object side and a biconvex lens L22 cemented together, a cemented lens consisting of a negative meniscus lens L23 with the convex surface facing the object side and a biconvex lens L24 cemented together, and a cemented lens consisting of a negative meniscus lens L25 with the convex surface facing the object side and a biconvex lens L26 cemented together, in the order from the object side. A third lens group G3 is composed of a cemented lens consisting of a negative meniscus lens L31 with the convex surface facing the object side, a biconvex lens L32, and a biconcave lens L32 cemented together, in the order from the object side.

A fourth lens group G4 is composed of a cemented lens consisting of a positive meniscus lens L41 with the convex surface facing the object side and a negative meniscus lens L42 with the convex surface facing the object side cemented together in the order from the object side. A fifth lens group G5 is composed of a cemented lens consisting of a biconcave lens L51 and a biconvex lens L52 cemented together in the order from the object side. In the first embodiment, the fourth lens group G4 has a negative refracting power and the fifth lens group G5 has a positive refracting power.

Values for the specifications of the microscope objective lens according to the first embodiment are listed in the following Table (2). In Table (2), f denotes the focal length of the entire objective lens system (the focal length of the objective lens only : mm), NA denotes the numerical aperture of the entire objective lens system, β denotes the magnification of a compound optical system which has the objective lens and the imaging lens combined with each other, and WD denotes an working distance (a distance along the optical axis between the object surface and the lens surface on the object side of the cover glass), respectively. Further, a surface number denotes the order of each lens surface from the object side, r denotes the radius of curvature (mm) of each lens surface, d denotes a distance (mm) between the lens surfaces, nd denotes a refractive index of each lens surface with respect to the d line (λ=587. 6 nm), and νd denotes an Abbe number of each lens surface with respect to the d line, respectively. The above denotations will be the same in the subsequent Table (3).

TABLE 2
f = 5
NA = 1.2
β = 40

| Surface | | | | | |
|---|---|---|---|---|---|
| number | r | d | nd | ν d | |
| | (Object | 0.20000 | 1.3330600 | 53.98 | (Immersion |
| | side) | | | | liquid) |
| 1 | ∞ | 0.17000 | 1.5221600 | 58.8 | (Cover |
| | | | | | glass) |
| 2 | ∞ | 0.70000 | 1.4585040 | 67.846 | (Lens L11) |
| 3 | −1.05080 | 3.90000 | 1.7550000 | 52.32 | (Lens L12) |
| 4 | −4.14110 | 0.10000 | | | |
| 5 | −13.79940 | 3.10000 | 1.5690700 | 71.3 | (Lens L13) |
| 6 | −7.01718 | 0.10000 | | | |
| 7 | 485.73421 | 1.00000 | 1.5268200 | 51.352 | (Lens L21) |
| 8 | 16.61844 | 7.60000 | 1.4856300 | 85.2 | (Lens L22) |
| 9 | −15.58323 | 0.20000 | | | |
| 10 | 44.73867 | 1.00000 | 1.5814400 | 40.757 | (Lens L23) |
| 11 | 16.90591 | 7.70000 | 1.4338520 | 95.247 | (Lens L24) |
| 12 | −19.99990 | 0.10000 | | | |
| 13 | 39.48550 | 1.00000 | 1.6968000 | 51.352 | (Lens L25) |
| 14 | 11.25516 | 7.50000 | 1.4338520 | 95.247 | (Lens L26) |
| 15 | −26.29344 | 0.10000 | | | |
| 16 | 21.08226 | 1.15000 | 1.5268200 | 51.352 | (Lens L31) |
| 17 | 11.08932 | 5.80000 | 1.4338520 | 95.247 | (Lens L32) |
| 18 | −22.68204 | 0.95000 | 1.5268200 | 51.352 | (Lens L33) |

| | | |
|---|---|---|
| 19 | 19.61223 | (d19 = variable) |

| | | | | | |
|---|---|---|---|---|---|
| 20 | 7.68181 | 4.90000 | 1.4978200 | 82.516 | (Lens L41) |
| 21 | 111.48760 | 2.70000 | 1.6968000 | 55.602 | (Lens L42) |
| 22 | 5.07235 | 4.20000 | | | |
| 23 | −5.78271 | 4.90000 | 1.5013700 | 56.41 | (Lens L51) |
| 24 | 53.90933 | 3.60000 | 1.5814400 | 40.757 | (Lens L52) |
| 25 | −10.09370 | 148.00000 | | | |

(Variable distance for the correction of aberration
fluctuations)

| t | WD | d19 |
|---|---|---|
| 0.11 | 0.24 | 1.68 |
| 0.17 | 0.20 | 0.50 |
| 0.18 | 0.19 | 0.30 |

(Values for the conditions)

f1=11.40393

f4=−36.27916

f5=4392.16037

(1)f/f1=0.4384

(2) ν21−ν22=54.49 (Cemented surface between L23 and L24)

(3) (n1-n2)/|R|=0.00838

(4) |f4/f5|=0.00826

(5) ν51−ν52=15.65

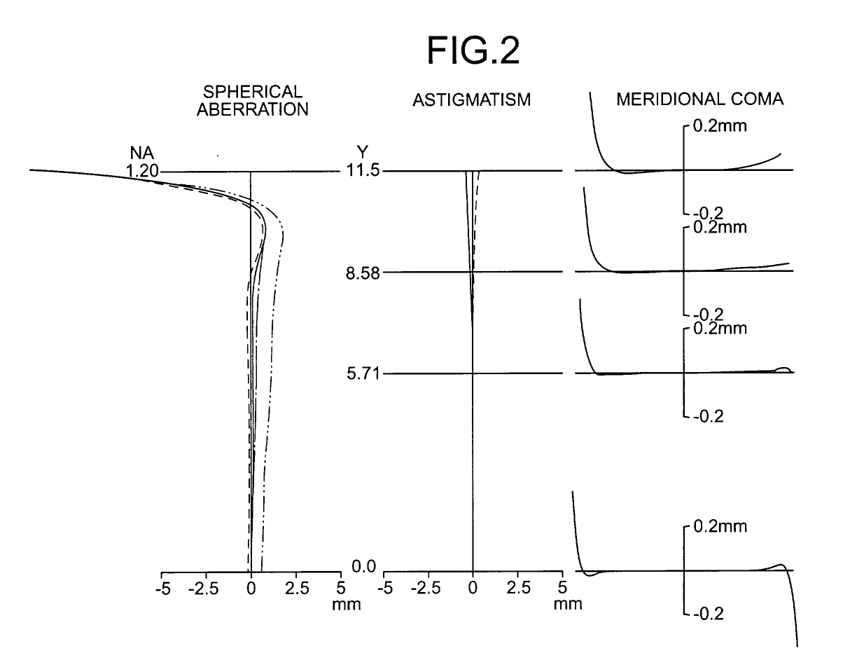

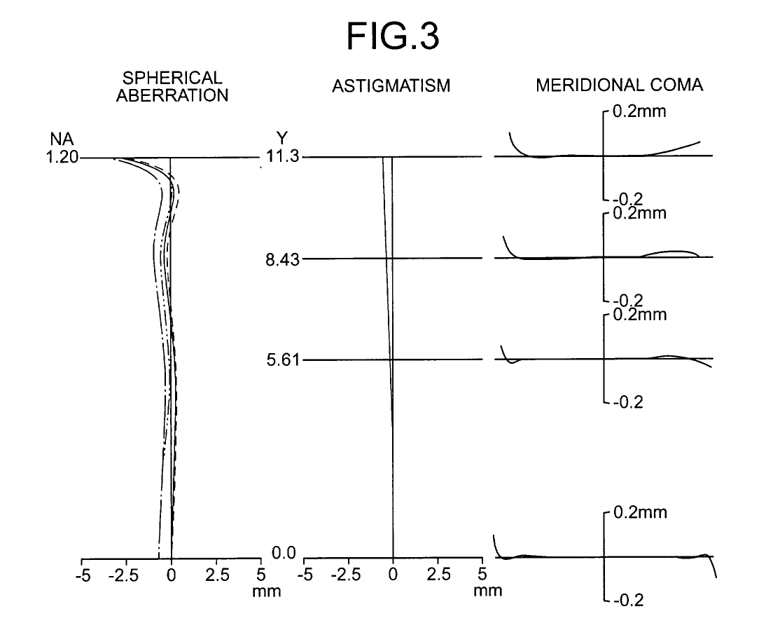

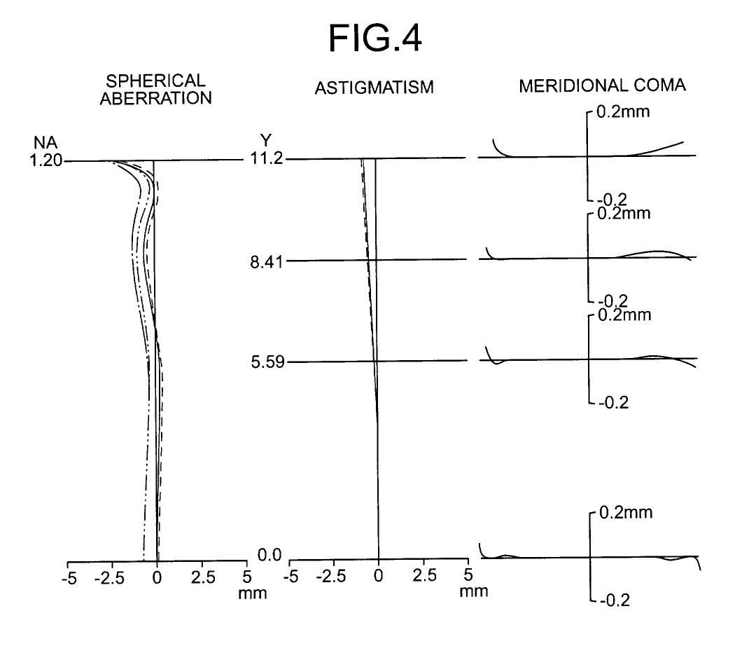

FIGS. 2 to 4 are aberration views according to the first embodiment. More specifically, FIG. 2 is a view of aberrations in a state that the thickness of the cover glass (t=0.11) is smaller than the standard thickness, FIG. 3 is a view of aberrations in a state that the thickness of the cover glass is equal to the standard thickness (t=0.17), and FIG. 4 is a view of aberrations in a state that the thickness of the cover glass (t=0.18) is larger than the standard thickness. In each of the aberration views, NA denotes a numerical aperture, and Y denotes an image height, respectively. Also, in each of the aberration views, a solid line denotes the d line (λ=587.6 nm), a broken line denotes the C line (λ=656.3 nm), a one-dot chain line denotes the F line (λ=486.1 nm), and a double-dot chain line denotes the g line (λ=435.8 nm), respectively.

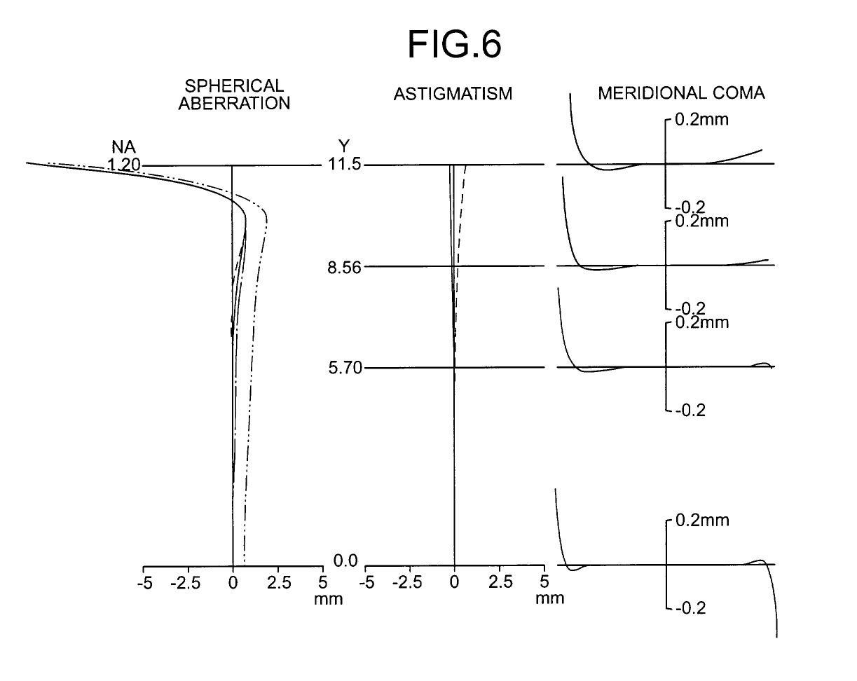

Further, the views of astigmatism and the views of meridional coma show aberrations with respect to the d line serving as a reference wavelength. In the views of astigmatism, a solid line indicates a sagittal image plane and a broken line a meridional image plane, respectively. The same denotations will be also used in the subsequent FIGS. 6 to 8. As seen from these aberration views, it is clear that the fluctuations of aberrations caused by a change of the thickness of the cover glass are satisfactorily corrected in the first embodiment, while securing the magnification of 40 and the numerical aperture of 1.2.

[Second Embodiment]

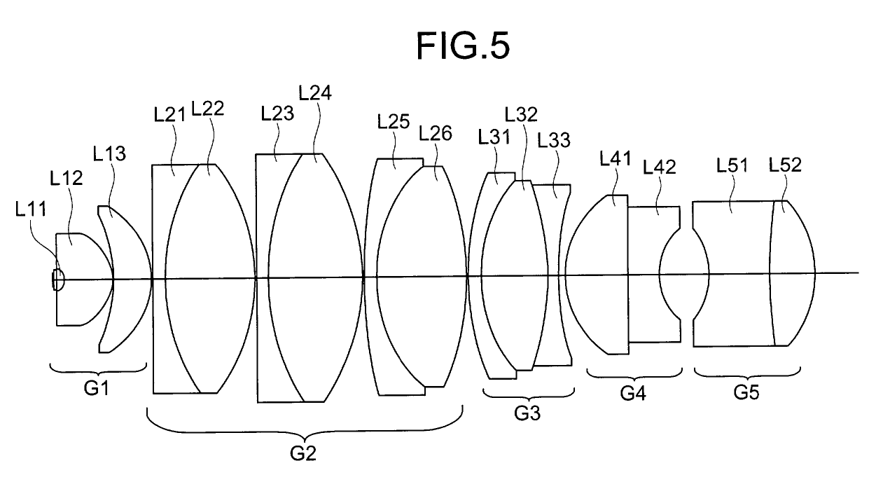

FIG. 5 is a view for schematically showing the configuration of a liquid immersion type microscope objective lens according to the second embodiment of the present invention. In the microscope objective lens shown in FIG. 5, a first lens group G1 is composed of a cemented lens consisting of a plano-convex lens L11 with the plane surface facing the object side and a negative meniscus lens L12 with the concave surface facing the object side cemented together, and a positive meniscus lens L13 with the concave surface facing the object side, in the order from the object side.

A second lens group G2 is composed of a cemented lens consisting of a negative meniscus lens L21 with the convex surface facing the object side and a biconvex lens L22 cemented together, a cemented lens consisting of a negative meniscus lens L23 with the convex surface facing the object side and a biconvex lens L24 cemented together, and a cemented lens consisting of a negative meniscus lens L25 with the convex surface facing the object side and a biconvex lens L26 cemented together, in the order from the object side. A third lens group G3 is composed of a cemented lens consisting of a negative meniscus lens L31 with the convex surface facing the object side, a biconvex lens L32, and a biconcave lens L33 cemented together, in the order from the object side.

A fourth lens group G4 is composed of a cemented lens consisting of a positive meniscus lens L41 with the convex surface facing the object side, and a negative meniscus lens L42 with the convex surface facing the object side cemented together, in the order from the object side. A fifth lens group G5 is composed of a cemented lens consisting of a biconcave lens L51 and a biconvex lens L52 cemented together, in the order from the object side. In the second embodiment, both the fourth lens group G4 and the fifth lens group G5 have the negative refracting power. Values for the specifications of the microscope objective lens according to the second embodiment are listed in the following Table (3).

TABLE 3
f = 5
NA = 1.2
β = 40

| Surface | | | | | |
|---|---|---|---|---|---|
| number | r | d | nd | ν d | |
| | (Object | 0.20000 | 1.3330600 | 53.98 | (Immersion |
| | liquid) | | | | plane) |
| 1 | ∞ | 0.17000 | 1.5221600 | 58.80 | (Cover |
| | | | | | glass) |
| 2 | ∞ | 0.70000 | 1.4585040 | 67.846 | (Lens L11) |
| 3 | −1.05080 | 3.90000 | 1.7550000 | 52.320 | (Lens L12) |
| 4 | −4.07010 | 0.10000 | | | |
| 5 | −14.73007 | 3.10000 | 1.5690700 | 71.3 | (Lens L13) |
| 6 | −7.20816 | 0.10000 | | | |
| 7 | 217.04742 | 1.00000 | 1.5520000 | 49.712 | (Lens L21) |
| 8 | 16.70806 | 7.40000 | 1.4978200 | 82.516 | (Lens L22) |
| 9 | −15.96046 | 0.15000 | | | |
| 10 | 294.75226 | 1.00000 | 1.5481390 | 45.869 | (Lens L23) |
| 11 | 18.38171 | 7.90000 | 1.4338520 | 95.247 | (Lens L24) |
| 12 | −17.86405 | 0.10000 | | | |
| 13 | 38.65553 | 1.00000 | 1.6968000 | 55.602 | (Lens L25) |
| 14 | 11.94183 | 7.70000 | 1.4338520 | 95.247 | (Lens L26) |
| 15 | −24.37475 | 0.10000 | | | |
| 16 | 20.49101 | 1.20000 | 1.5317210 | 48.966 | (Lens L31) |
| 17 | 11.98197 | 5.60000 | 1.4338520 | 95.247 | (Lens L32) |
| 18 | −24.92420 | 0.95000 | 1.5520000 | 49.712 | (Lens L33) |

| | | |
|---|---|---|
| 19 | 23.19503 | (d19 = variable) |

| | | | | | |
|---|---|---|---|---|---|
| 20 | 7.78436 | 5.30000 | 1.4978200 | 82.516 | (Lens L41) |
| 21 | 669.88446 | 2.60000 | 1.6968000 | 55.602 | (Lens L42) |
| 22 | 5.05299 | 4.20000 | | | |
| 23 | −5.94993 | 4.90000 | 1.5520000 | 49.712 | (Lens L51) |
| 24 | 43.93151 | 3.60000 | 1.6034200 | 38.027 | (Lens L52) |
| 25 | −10.17419 | 148.00000 | | | |

(Variable distance for the correction of aberration
fluctuations)

| t | WD | d19 |
|---|---|---|
| 0.11 | 0.24 | 1.47 |
| 0.17 | 0.20 | 0.50 |
| 0.18 | 0.19 | 0.33 |

(Values for the conditions)

f1=10.8824

f4=−34.54139

f5=−411.9287

(1)f/f1=0.4595

(2) ν21−ν22=49.378 (cemented surface between L23 and L24)

(3) (n1−n2)/|R|=0.00817

(4) |f4/f5|=0.0839

(5) ν51−ν52=11.68

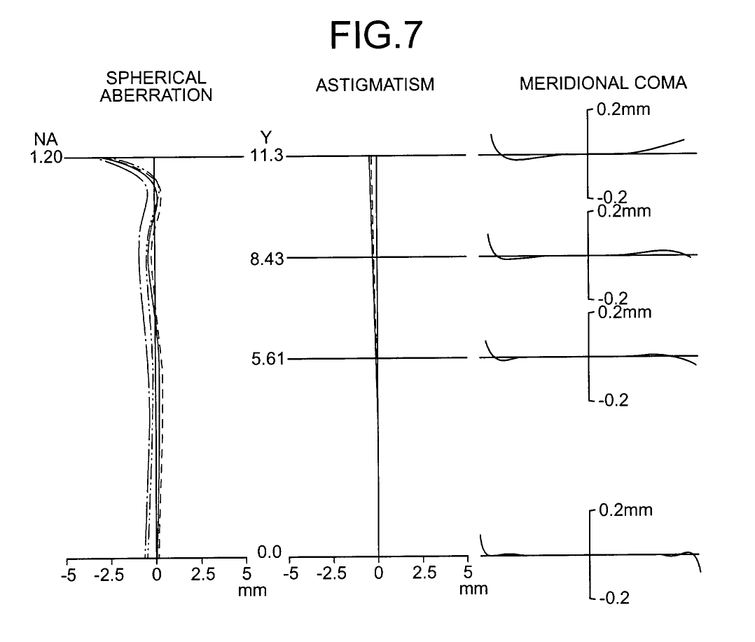

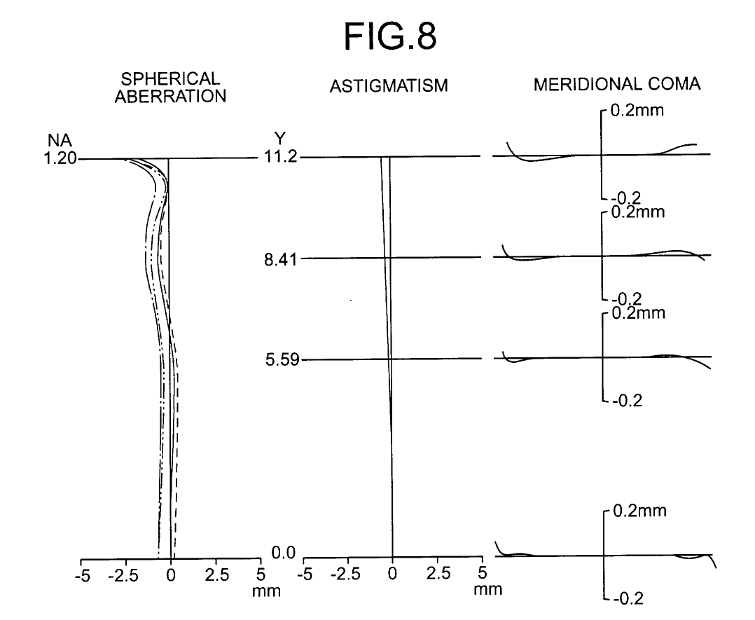

FIGS. 6 to 8 are aberration views according to the second embodiment. More specifically, FIG. 6 is a view of aberrations in a state that the thickness of the cover glass (t=0.11) is smaller than the standard thickness, FIG. 7 is a view of aberrations in a state that the thickness of the cover glass is equal to the standard thickness (t=0.17), and FIG. 8 is a view of aberrations in a state that the thickness of the cover glass (t=0.18) is larger than the standard thickness. As seen from these aberration views, it is clear that the fluctuations of aberrations which may be caused by a change of the thickness of the cover glass can be satisfactorily corrected in the second embodiment, like in the first embodiment, while securing the magnification of 40 and the numerical aperture of 1.2.

As described above, according to the present invention, it is possible to realize a liquid immersion type microscope objective lens of the apochromat class, which, even when a fluorescent glass material is used, has the magnification of about 40 and the numerical aperture (NA) of about 1.2, with the excellent flatness of the image surface, and which can correct fluctuations in the aberrations caused by a change of the thickness of the cover glass, or the like.

What is claimed is:

1. A liquid immersion type microscope objective lens comprising a first lens group G1 having a positive refracting power, a second lens group G2 having a positive refracting power, a third lens group G3 having a negative refracting power, a fourth lens group G4, and a fifth lens group G5, in the named order from an object side, characterized in that:
said first lens group G1 has a cemented lens which comprises a plano-convex lens with the plane surface facing the object side and a meniscus lens with the concave surface facing the object side cemented together, and a positive meniscus lens with the concave surface facing the object side, in the order from the object side;
said second lens group G2 has a plurality of cemented surfaces having a negative refracting power;
said third lens group G3 has a cemented lens which comprises a negative lens, a positive lens, and a negative lens cemented together, in the order from the object side;
said fourth lens group G4 has a cemented meniscus lens which comprises a positive lens and a negative lens with the concave surface having a large curvature facing an image side, cemented together in the order from the object side;
said fifth lens group G5 has a cemented meniscus lens which comprises a negative lens with the concave surface having a large curvature facing the object side and a positive lens cemented together in the order from the object side; and
said fourth lens group G4 and said fifth lens group G5 are arranged to be integrally movable along the optical axis in order to correct the aberration fluctuations.

2. A liquid immersion type microscope objective lens according to claim 1, wherein the following condition is satisfied:
0.4<f/f1<0.6,
where the focal length of said objective lens is f, and the focal length of said first lens group G1 is f1.

3. A liquid immersion type microscope objective lens according to claim 1 or 2, wherein when the Abbe numbers of the positive lens and the negative lens for forming the cemented surface having the negative refracting power in said second lens group G2 are respectively ν21 and ν22, the following condition is satisfied on at least one of the cemented surfaces having the negative refracting power:
49<ν21−ν22.

4. A liquid immersion type microscope objective lens according to claim 3, wherein the following condition is satisfied:
(n1−n2)/|R|<0.01,
where, in the third lens group G3, the refractive index of the negative lens on the object side with respect to the d line is n1, the refractive index of the central positive lens with respect to the d line is n2, and the radius of curvature of the cemented surface formed by the negative lens on the object side and the central positive lens is R.

5. A liquid immersion type microscope objective lens according to claim 4, wherein the following condition is satisfied:

|f4/f5|<0.1,
where the focal length of said fourth lens group G4 is f4, and the focal length of said fifth lens group G5 is f5.

6. A liquid immersion type microscope objective lens according to claim 5, wherein, in said fifth lens group G5, the following condition is satisfied:
13<ν51−ν52,
where the Abbe number of said negative lens is ν51 and the Abbe number of said positive lens is ν52.

7. A liquid immersion type microscope objective lens according to claim 1 or 2, wherein the following condition is satisfied:
(n1−n2)/|R|<0.01,
where, in the third lens group G3, the refractive index of the negative lens on the object side with respect to the d line is n1, the refractive index of the central positive lens with respect to the d line is n2, and the radius of curvature of the cemented surface formed by the negative lens on the object side and the central positive lens is R.

8. A liquid immersion type microscope objective lens according to claim 7, wherein the following condition is satisfied:

|f4/f5|<0.1,
where the focal length of said fourth lens group G4 is f4, and the focal length of said fifth lens group G5 is f5.

9. A liquid immersion type microscope objective lens according to claim 8, wherein, in said fifth lens group G5, the following condition is satisfied:
13<ν51−ν52,
where the Abbe number of said negative lens is ν51 and the Abbe number of said positive lens is ν52.

10. A liquid immersion type microscope objective lens according to claim 1 or 2, wherein
the following condition is satisfied:

|f4/f5|<0.1,
where the focal length of said fourth lens group G4 is f4, and the focal length of said fifth lens group G5 is f5.

11. A liquid immersion type microscope objective lens according to claim 10, wherein, in said fifth lens group G5, the following condition is satisfied:
13<ν51−ν52,
where the Abbe number of said negative lens is ν51 and the Abbe number of said positive lens is ν52.

12. A liquid immersion type microscope objective lens according to claim 1 or 2, wherein, in said fifth lens group G5, the following condition is satisfied:
13 <ν51−ν52,
where the Abbe number of said negative lens is ν51 and the Abbe number of said positive lens is ν52.
